(19) United States
(12) Patent Application Publication
(10) Pub. No.: US 2014/0314389 A1
(43) Pub. Date: Oct. 23, 2014

(54) SEGMENTED CONTENT REFERENCE CIRCULATION

(71) Applicant: Broadcom Corporation, Irvine, CA (US)

(72) Inventor: Murat Mese, Rancho Palos Verdes, CA (US)

(73) Assignee: Broadcom Corporation, Irvine, CA (US)

(21) Appl. No.: 13/897,874

(22) Filed: May 20, 2013

Related U.S. Application Data
(60) Provisional application No. 61/814,938, filed on Apr. 23, 2013.

(51) Int. Cl. G11B 27/10

(52) U.S. Cl. CPC G11B 27/105
USPC 386/241

(57) ABSTRACT

Aspects of segmented content reference circulation are described. In one embodiment, a marker is received in association with content under display. A type and attribute of the marker are evaluated. The marker may be evaluated as a start, end, or range type of marker, for example. The attribute of the marker may be evaluated as a playback start time or end time, for example. With reference to the start or end time, a segmented resource identifier is generated. The segmented resource identifier may include a uniform resource locator, as a reference to the content under display, and a playback attribute for rendering playback of the content starting at the start time or ending at the end time, for example. After being circulated, a playback device can rely upon the segmented resource identifier to request content for playback based on the start or end time playback attributes.

### CROSS-REFERENCE TO RELATED APPLICATIONS

This application claims the benefit of U.S. Provisional Application No. 61/814,938, filed Apr. 23, 2013, the entire contents of which are hereby incorporated herein by reference.

### BACKGROUND

Computing systems, devices, and networks are now relied upon for the distribution and circulation of media content such as video and audio content. As compared to conventional broadcast systems, the computing systems, devices, and networks provide a more flexible means for the distribution of media content. For example, rather than awaiting for a broadcast time of a particular video program, a digital copy of the program, residing on a content server coupled to a network, may be accessed at any time by each of a plurality of playback devices coupled to the network.

With the design and adoption of playback devices having various sizes and forms, many users have access to playback devices throughout the day. Thus, with the availability of playback devices and media content residing on content servers, media content is being distributed to consumers in a more flexible manner and at a greater frequency.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates an example system and network for segmented content reference circulation according to various embodiments described herein.

FIG. 2A illustrates an example content display and associated start content marker command gesture relied upon by the system for segmented content reference circulation of FIG. 1, according to various embodiments described herein.

FIG. 2B illustrates an example content display and associated end content marker command gesture relied upon by the system for segmented content reference circulation of FIG. 1, according to various embodiments described herein.

FIG. 2C illustrates an example content display and associated range content marker command gesture relied upon by the system for segmented content reference circulation of FIG. 1, according to various embodiments described herein.

FIG. 3 illustrates example components of content for selection and segmentation by the system for segmented content reference circulation of FIG. 1, according to various embodiments described herein.

FIG. 4 illustrates an example format of a segmented resource identifier generated by the system for segmented content reference circulation of FIG. 1, according to various embodiments described herein.

FIG. 5 illustrates an example organization of a profile store relied upon by the system for segmented content reference circulation of FIG. 1, according to various embodiments described herein.

FIG. 6 illustrates an example process flow of a segmented content reference circulation process performed by the system of FIG. 1, according to various embodiments described herein.

FIG. 7 illustrates an example schematic block diagram of a computing architecture that may be employed by one or more elements of the system of FIG. 1, according to various embodiments described herein.

### DETAILED DESCRIPTION

Computing systems, devices, and networks are now relied upon for the distribution and circulation of media content such as video and audio content. As compared to conventional broadcast systems, the computing systems, devices, and networks provide a more flexible means for the distribution of media content. For example, rather than awaiting for a broadcast time of a particular video program, a digital copy of the program, residing on a content server coupled to a network, may be accessed at any time by each of a plurality of playback devices coupled to the network. Further, with the design and adoption of playback devices having various sizes and forms, many users have access to playback devices throughout the day. Thus, with the availability of playback devices and media content residing on content servers, media content is being distributed to consumers in a more flexible manner and at a greater frequency.

Generally, computing systems, devices, and networks rely upon various types of uniform reference identifiers for the identification of media content that is available for distribution over a network. For example, as one form of a uniform resource identifier, a computing device may rely upon a link that refers to content stored on a content server, to request the content for playback. The link may include a uniform resource locator or uniform resource name that identifies content stored on a content server. Using the link, the content may be requested from the content server for playback on a playback device. It should be appreciated that links to content may be shared between users over a network. Thus, if a user of a playback device identifies media content of a particular interest, the user may distribute a link including a uniform resource identifier that identifies the content to a friend or family member. Additionally, the user may distribute a link including a uniform resource identifier by posting the link to a social networking website.

As noted above, computing systems, devices, and networks permit flexibility in the distribution of media content. This flexibility is attributed not only to the time at which content may be distributed or to the various devices to which the content may be distributed, but also to the manner in which the content may be played back. For example, content distributed from a content server may be provided in part, so that only a segment of the content is played back. Thus, it may not be necessary to view an entire program of content, as was the case in broadcast distribution of programs.

As for a user of a playback device that receives a link to content, rather than viewing the content in its entirety, the user may wish to watch or listen to only a certain portion or segment of the content. Similarly, the user may wish to watch or listen to certain portions or segments of the content in a particular order of playback. In that context, a user that shares a link to content may desire to identify only certain segments or components of the content for playback by another. In other words, an individual that shares a link may desire to highlight only certain portions or segments of the content identified by the link, because only certain portions are relevant.

According to aspects of the embodiments described herein, the generation of segmented content references is described. A segmented content reference may include a uniform resource locator that identifies content for playback, along with additional syntax parameters or attributes that specify one or more of a playback start time, a playback end time, playback start and end times, or a playback time range for the content, for example. The additional syntax parameters or attributes may also specify one or more components of content for playback, such as audio, video, or metadata components.

According to other aspects of the embodiments described herein, a segmented content reference may be generated by a computing device based on the receipt of one or more content markers designated during a time of content playback. In other words, while a user watches content on a display, the user may designate various content markers, by one or more command gestures, for example, which are evaluated by a computing device to generate a segmented resource identifier. In other aspects, a segmented resource identifier may be generated based on the content markers and a profile for generation and circulation of the segmented resource identifier. Once generated, the segmented resource identifier may be circulated to one or more parties or posted to a social networking website. Other parties may rely upon the segmented resource identifier to identify content for playback, along with certain playback times, time ranges, or components for playback. In this manner, by using segmented resource identifiers, content may be more flexibly distributed and circulated.

Turning now to the drawings, a general description of an example system and network for segmented content reference circulation is provided, followed by a discussion of the operation of the same.

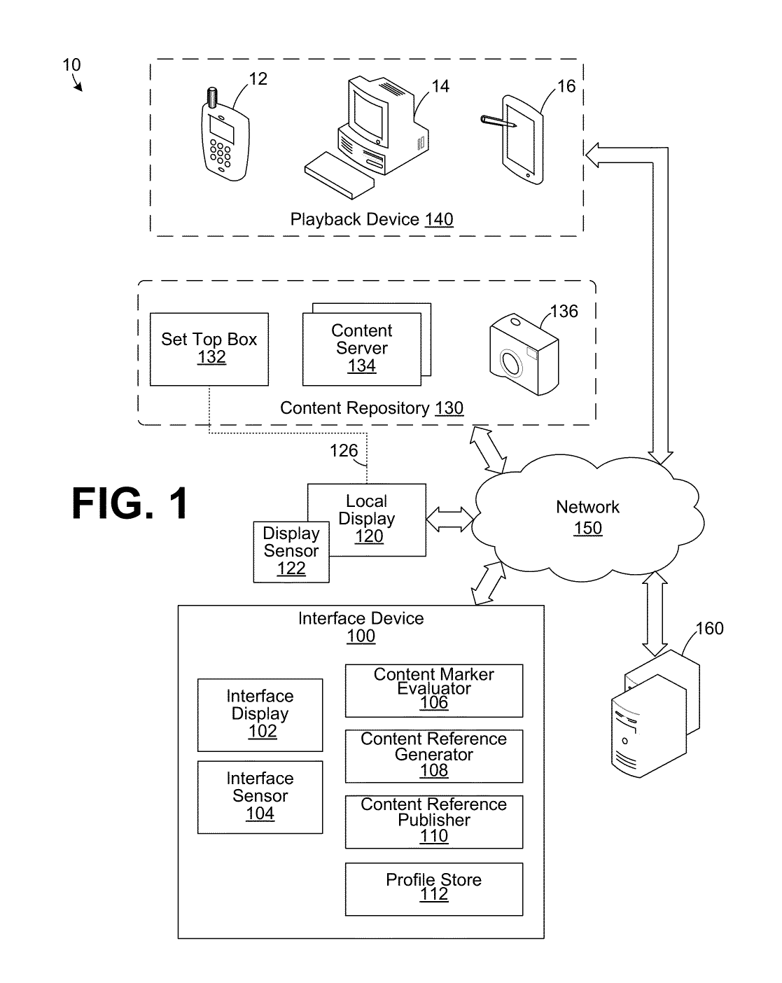

FIG. 1 illustrates an example system 10 for segmented content reference circulation according to various embodiments described herein. The system 10 includes an interface device 100, a local display 120, a content repository 130, a playback device 140, and a network 150. In certain embodiments, the system 10 further includes one or more social networking websites or distribution channels 160. As described in detail below, content for playback may be provided by the content repository 130 to the interface device 100, the local display 120, or the playback device 140 via the network 150.

The network 150 may include the Internet and public and private intranets, extranets, wide area networks (WANs), local area networks (LANs), wired networks, wireless networks, other suitable networks, and/or combinations thereof. It is noted that the interface device 100, the local display 120, the content repository 130, and the playback device 140 may communicate with each other using one or a combination of various network or internet protocols and syntaxes known in the suite of internet protocols and syntaxes, such as hypertext transfer protocol (HTTP), real-time transport protocol (RTP), real time streaming protocol (RTSP), real time messaging protocol (RTMP), user datagram protocol (UDP), and transmission control protocol (TCP), for example, among other protocols and syntaxes for communicating data via the network 150, without limitation. Generally, the social networking websites or distribution channels 160 may include any known network-based social networking, distribution, or circulation means, such as FACEBOOK®, TWITTER®, or LINKEDIN®, for example.

The local display 120 may be embodied as a television set or similar type of display or monitor. In certain embodiments, the local display 120 includes a display sensor 122, as further described below. Further, it should be appreciated that the local display 120 can include speakers or other means for rendering sound from an audio component of media content. Generally, the content repository 130 may be embodied as any device or system capable of storing and/or serving content to other devices via the network 150. In various embodiments, the content repository 130 may include a set top box 132, a content server 134, or a standalone device 136, for example, among other devices or systems. Generally, the playback device 140 may be embodied as any device capable of rendering content for playback, at the request of a user. In various embodiments, the playback device 140 may be embodied as a handheld device 12, a desktop or laptop computer 14, or a tablet device 16, for example, among other devices or systems. The devices described and illustrated in connection with the content repository 130 and the playback device 140 are provided by way of example only, and other devices are within the scope and spirit of the embodiments.

The set top box (STB) 132 may be embodied as a device including, among other elements, at least one tuner, a storage means, and encoding, decoding, and playback processing circuitry. The STB 132 may be coupled to various antennas and/or broadband networks in addition to the network 150. For example, the STB 132 may be coupled to a coaxial cable network. In this context, the STB 132 may be configured to receive media content programs distributed over the coaxial network (or a separate antenna) and record them to a local storage means. The STB 132 may be directly coupled to the local display 120 via a direct connection 126, such as a component or High Definition Multimedia Interface (HMDI) cable, or via the network 150.

In addition to displaying content on the local display 120, the STB 132 may be configured to distribute media content to other devices via the network 150. For example, the playback device 140 may rely upon a segmented content reference, as described herein, to identify and request a portion or segment of content recorded on the STB 132 for playback. After a request for content is received, the STB 132 is configured to serve the content for playback. As further described below, the STB 132 may serve media content for playback according to certain syntax parameters or attributes of a segmented content reference.

The content server 134 may be embodied as a computer, computing device, or computing system. In certain embodiments, the content server 134 may include one or more computing devices arranged, for example, in one or more server or computer banks. The content server 134 may be located at a single installation site or distributed among different geographical locations. For example, the content server 134 may include a plurality of computing devices that together include a cloud computing resource, a grid computing resource, and/or other distributed computing arrangement or environment.

The content server 134, generally, stores media content for distribution. Because the content server 134 is coupled to other devices via the network 150, the content server 134 can distribute stored content to various devices, such as the interface device 100, the local display 120, and the playback device 140. The playback device 140 may rely upon a segmented content reference, as described herein, to identify and request a portion or segment of content stored on the content server 134 for playback. After a request for content is received, the content server 134 is configured to serve the content for playback. As further described below, the content server 134 may serve content for playback according to certain syntax parameters of a segmented content reference.

The standalone device 136 may be embodied as a camera, video recorder, audio recorder, or other content capture device that captures and locally stores content. Generally, once connected to the network 150, the standalone device 136 can distribute stored content to various devices, such as the interface device 100, the local display 120, and the playback device 140, via the network 150. For example, the playback device 140 may rely upon a segmented content reference, as described herein, to identify and request a portion or segment of content stored on the standalone device 136 for playback. As further described below, the standalone device 136 may serve content for playback according to certain playback attributes of a segmented content reference.

Turning to the interface device 100, the device 100 may be embodied by a general purpose computing device, such as a desktop or laptop computer, or a more purpose-specific computing device, such as a tablet or handheld telephone computing device, for example, without limitation. The interface device 100 includes an interface display 102, an interface sensor 104, a content marker evaluator 106, a content reference generator 108, a content reference publisher 110, and a profile store 112. It should be appreciated that the interface device can also include speakers or other means for rendering sound from an audio component of media content. The individual elements of the interface device 100 are described in further detail below.

The interface display 102 provides a display for the interface device 100. Various user interface displays may be provided on the interface display 102, for control and operation of the interface device 100 and/or other devices coupled to the network 150. Further, playback of media content may be provided on the interface display 102, for user consumption. The interface sensor 104 of the interface device 100 may be embodied as a capacitive touch sensor of the interface display 102, an orientation or acceleration sensor, and/or an image sensor or camera, for example, among other sensors. As further described below, the interface sensor 104 may be relied upon by the interface device 100 to identify, capture, and/or register a content marker command input provided by a user. The content marker command input may take the form of a gesture command input, for example.

It is noted that the display sensor 122 of the display 120 may be similar to the interface sensor 104 of the interface device 100, and may identify, capture, and/or register a content marker command input provided by a user. It is also noted that, in certain exemplary embodiments, the interface sensor 104 may be relied upon to identify and capture a content marker command input while the interface display 102 and/or the local display 120 displays media content. Similarly, in certain embodiments, the display sensor 122 may be relied upon to identify and capture a content marker command input while the local display 120 displays media content. In this context, any captured content marker command input may be associated or attributed to the media content being displayed, and may be evaluated in association with the media content being displayed.

In one embodiment, the content marker evaluator 106 of the interface device 100 is configured to receive a content marker command input based on user input captured by the interface sensor 104 or the display sensor 122. The content marker evaluator 106 may receive the content marker command input while content is being displayed on the interface display 102 and/or the local display 120. Upon receipt of a content marker command input, the content marker evaluator 106 is configured to evaluate a type of the content marker command input. As further described below, a content marker command input may include a start, stop, range, media component, forward range, reverse range, or publish type commands. In certain aspects, a type of a content marker may be evaluated with reference to a user profile stored in the profile store 112. Further, the content marker command input may be evaluated in association with any content being displayed on the interface display 102 and/or the local display 120.

In addition to evaluating a type of the content marker command input, the content marker evaluator 106 is further configured to identify a segment point of certain content with reference to the type of the marker. In exemplary embodiments, the segment point may be identified as a start time, stop time, or time range, for example, of content being displayed, when a content marker command input is received. The segment point may be relied upon by the content reference generator 108 to generate a segmented resource identifier, as described in further detail below.

It is noted that the content marker evaluator 106 may receive several content marker command inputs while content is being displayed on the interface display 102 and/or the local display 120. For example, after a first content marker command input is received at a first time, a second content marker command input may be received at a second time. Upon receipt of a second content marker, the content marker evaluator 106 may evaluate a type of the second marker and identify a second segment point of content with reference to the second marker. The second segment point may be relied upon by the content reference generator 108 to generate a segmented resource identifier, as described in further detail below.

Generally, the content reference generator 108 is configured to generate a segmented resource identifier that identifies content for playback and includes a playback attribute based on one or more segment points identified by the content marker evaluator 106. Aspects of segmented resource identifiers and the parameters and/or attributes of the segmented resource identifiers are described in further detail below in connection with FIG. 4.

After a segmented resource identifier is generated by the content reference generator 108, the content reference publisher 110 is configured to identify a party and/or channel for circulation of the segmented resource identifier. In certain embodiments, the content reference generator 108 may identify the party and/or channel for circulation based on profile information stored in the profile store 112. The party for circulation may include an individual or group of individuals, such as a family member, group of family members, friend, or group of friends, for example. The channel for circulation may include one or more e-mail addresses or short messaging service (SMS) or multimedia messaging service (MMS) addresses. Alternatively or additionally, the channel for circulation may include one or more of the social networking websites or distribution channels 160, for example, among other network distribution or circulation means. After the content reference publisher 110 has identified a party and channel for circulation of a segmented resource identifier, the content reference publisher 110 is configured to publish the segmented resource identifier to the party via the channel for circulation.

Once a segmented resource identifier is circulated to a party, the party may rely upon the segmented resource identifier to identify and request a portion, segment, or component of content for playback. The content may be identified by the segmented resource identifier as being stored on the STB 132, the content server 134, or the standalone device 136, for example, and requested for playback. The STB 132, content server 134, or standalone device 136 may serve the identified content for playback according to certain playback attributes of the segmented resource identifier. For example, with reference to a playback attribute of the segmented resource identifier, the STB 132, content server 134, or standalone device 136 may serve identified content at a particular start time. As another example, with reference to a playback attribute, the STB 132, content server 134, or standalone device 136 may serve a particular time range or component of identified content.

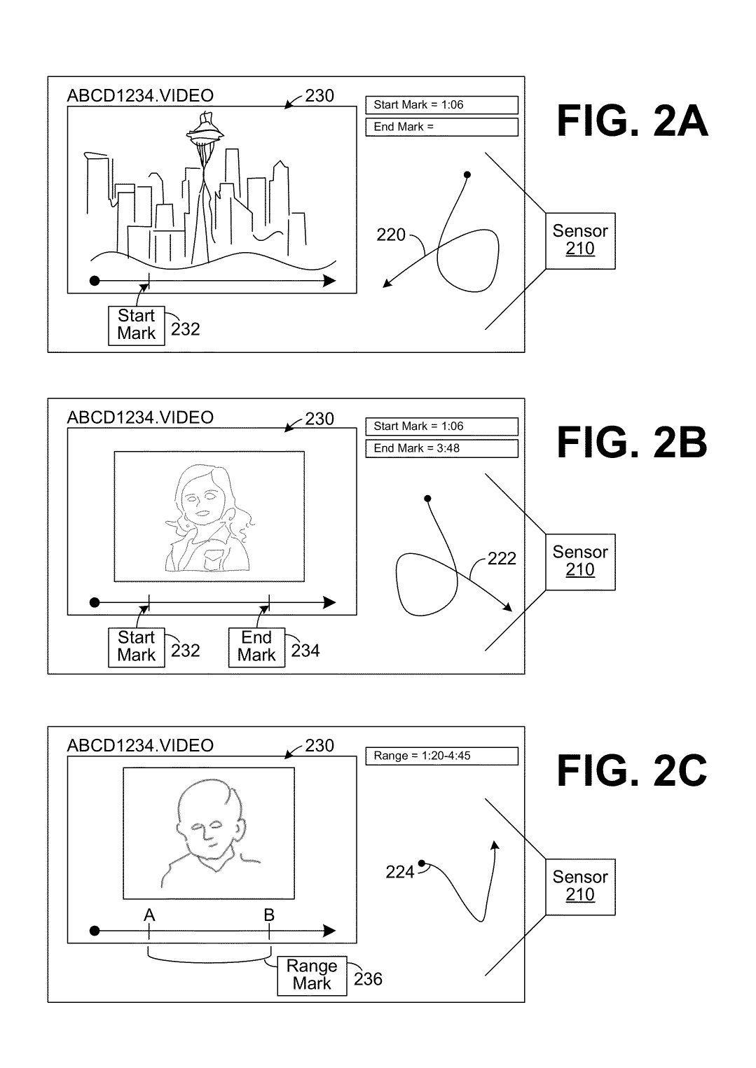

FIG. 2A illustrates an example content display 230 and associated start content marker command gesture 220 relied upon by the system 10 of FIG. 1, according to various embodiments described herein. In FIG. 2A, the content display 230 includes a display of video content. The video content rendered as the content display 230 may be stored on the content repository 130 and provided to the interface device 100 and/or the local display 120 (FIG. 1), for playback display. In one embodiment, the interface device 100 may be relied upon to retrieve and render content stored on the content repository 130 as the content display 230. In other embodiments, the interface device 100 may be relied upon to direct the local display 120 to display the video content from the content repository 130 as the content display 230.

While the video content from the content repository 130 is being displayed as the content display 230, one or more gestures of a user may be identified, captured, and/or registered by the sensor 210 as content marker command inputs. The sensor 210 may be representative of either the interface sensor 104 of the interface device 100 or the display sensor 122 of the local display 120 (FIG. 1), for example, and may be embodied as a capacitive display touch sensor, an orientation or acceleration sensor, and/or an image sensor or camera, among other sensors. As illustrated in FIG. 2A, the sensor 210 may identify, capture, and/or register the content marker command gesture 220.

The content marker command gesture 220 may be identified by the sensor 210 in response to a user's touch on a capacitive touch sensor, the user's movement of an orientation or acceleration sensor in a handheld device, or the movement of the user's hand before an image sensor or camera. The identification of a gesture-type marker input by the sensor 210 provides one means for marker command input. However, other means for identifying and registering content marker command inputs are within the scope and spirit of the embodiments described herein. For example, a user may directly specify a type and attribute for a content marker using one or more entry fields of a user interface via a hardware or software keyboard or other suitable input device.

Based on the content marker command gesture 220 identified by the sensor 210, the content marker evaluator 106 of the interface device 100 (FIG. 1) may evaluate a type and attribute of the content marker command gesture 220. For example, based on feedback provided by the sensor 210, the content marker evaluator 106 may identify that the content marker command gesture 220 includes a start type of marker 232, as illustrated in FIG. 2A. The content marker evaluator 106 may identify the type of the maker based on a shape or style of the content marker command gesture 220, as captured by a capacitive touch.

Further, based on a timing at which the gesture 220 is identified by the sensor 210, the content marker evaluator 106 may evaluate a timing associated with the marker, as an attribute of the type of the marker. In one embodiment, the timing at which the gesture 220 is identified may be evaluated with reference to a playback timing of the video content on the content display 230. In FIG. 2A, the content marker evaluator 106 identifies the content marker command gesture 220 as being a start type marker 232 associated with a start attribute timing of 1:06 minutes. These type and timing attributes evaluated by the content marker evaluator 106 may be relied upon by the content reference generator 108 (FIG. 1) to generate a segmented resource identifier, as described herein.

FIG. 2B illustrates the content display 230 and associated end content marker command gesture 222 relied upon by the system 10 of FIG. 1, according to various embodiments described herein. With reference to FIG. 2B, it is noted that the sensor 210 may identify more than one gesture during playback of content. For example, the gesture 222 may be identified at some time after the gesture 220. Again, the content marker command gesture 222 may be identified by the sensor 210 in response to a user's touch on a capacitive touch sensor, the user's movement of an orientation or acceleration sensor in a handheld device, or the movement of the user's hand before an image sensor or camera. Here, it is noted that the gesture 222 of FIG. 2B is distinguished from the gesture 220 of FIG. 2A, at least in shape.

Based on the content marker command gesture 222 identified by the sensor 210, the content marker evaluator 106 of the interface device 100 (FIG. 1) may evaluate a type and attribute of the content marker command gesture 222. For example, based on feedback provided by the sensor 210, the content marker evaluator 106 may identify that the content marker command gesture 222 includes an end type of marker 234, as illustrated in FIG. 2B. The content marker evaluator 106 may identify the type of the maker based on a shape or style of the content marker command gesture 222.

Further, based on a timing at which the gesture 222 is identified by the sensor 210, the content marker evaluator 106 may evaluate a timing associated with the marker, as an attribute of the type of the marker. In one embodiment, the timing at which the gesture 222 is identified may be evaluated with reference to a playback timing of the video content on the content display 230. In FIG. 2B, the content marker evaluator 106 identifies the content marker command gesture 222 as being an end type marker 234 associated with an end attribute timing of 3:48 minutes. These type and timing attributes evaluated by the content marker evaluator 106 may be relied upon by the content reference generator 108 (FIG. 1) to generate a segmented resource identifier, as described herein.

FIG. 2C illustrates an example content display and associated range content marker command gesture 224 relied upon by the system 10 of FIG. 1, according to various embodiments described herein. With reference to FIG. 2C, it is noted that the sensor 210 may identify a range of content during playback of the content. The content marker command gesture 224 may be identified by the sensor 210 in response to a user's touch on a capacitive touch sensor, the user's movement of an orientation or acceleration sensor in a handheld device, or the movement of the user's hand before an image sensor or camera. Here, it is noted that the gesture 224 of FIG. 2C is distinguished from the gestures 220 and 222 of FIGS. 2A and 2B, at least in shape.

Based on the content marker command gesture 224 identified by the sensor 210, the content marker evaluator 106 of the interface device 100 (FIG. 1) may evaluate a type and attribute of the content marker command gesture 224. In FIG. 2C, the content marker evaluator 106 identifies the content marker command gesture 224 as a range type of marker 236. Further, based on a timing at which the gesture 224 is identified by the sensor 210, the content marker evaluator 106 may evaluate a timing associated with the marker, as an attribute of the type of the marker. In one embodiment, the timing at which the gesture 224 is identified may be evaluated with reference to a playback timing of the video content on the content display 230. In FIG. 2C, the content marker evaluator 106 identifies the content marker command gesture 224 as being a range type marker 236 associated with a range timing attribute of 1:20-4:45 minutes. These type and timing attributes evaluated by the content marker evaluator 106 may be relied upon by the content reference generator 108 (FIG. 1) to generate a segmented resource identifier, as described herein.

It is noted that the example gestures 220, 222, and 224 illustrated in FIGS. 2A-2C are provided by way of example only, as other gestures are within the scope and spirit of the embodiments described herein. Additionally, as described above, other means for identifying and registering content marker command inputs are within the scope and spirit of the embodiments described herein. For example, a user may directly input or specify attributes for start type markers 232, end type markers 234, and range type markers 236 using entry fields of a user interface, for example.

Further, beyond start, end, and range gesture markers, a gesture marker may be provided to identify a certain component of content under display. That is, for video content under display, a gesture may be provided to select or mark only a single frame of the video content. Alternatively, a gesture may be provided to select or mark only an audio component of the content. In this context, a segmented resource identifier may identify content, specify only a particular component of that content, and a particular start, end, or range time of that content for playback. Further, a gesture may specify a party or channel for distribution of a segmented resource identifier.

It is additionally noted that any gesture marker may be evaluated by the content marker evaluator 106 in connection with profile information stored in the profile store 112 (FIG. 1). The profile store 112 may include an index or database of marker attributes or parameters, per user, for various types of gesture markers. Thus, a user may specify default start, stop, and range gestures, for example, corresponding to start, stop, and range content marker commands. Similarly, the user may specify certain gestures as corresponding to corresponding parties and/or channels for distribution of a segmented resource identifier. It is noted that, although the profile store 112 is illustrated in FIG. 1 as being stored in the interface device 100, the embodiments described herein are not so limited. In various embodiments, the profile store 112 may be stored in the set top box 132, the content server 134, or in one or more servers coupled to the network 150. In other embodiments, the profile store 112 may be stored by the social networking websites or distribution channels 160. Other locations for storage of the profile store 112 are within the scope and spirit of the embodiments described herein.

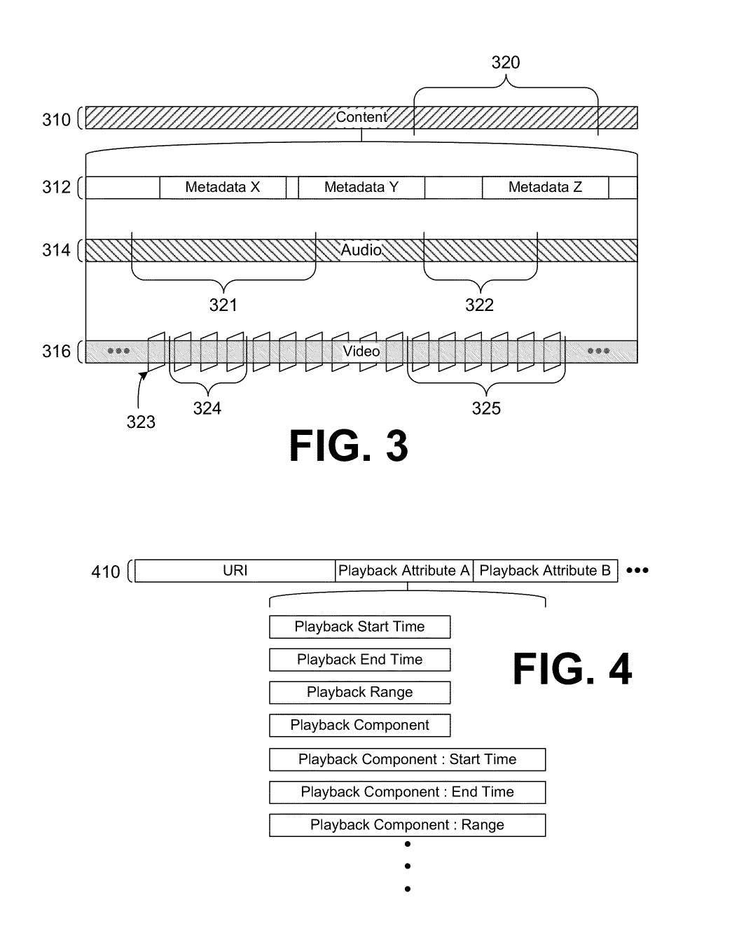

FIG. 3 illustrates example components of content for selection and segmentation by the system 10 of FIG. 1, according to various embodiments described herein. Generally, FIG. 3 illustrates video content 310 which may be stored on the content repository 130 (FIG. 1). The video content 310 includes metadata 312, an audio component 314, and a video component 316. The metadata 312 includes metadata X, metadata Y, and metadata Z components or segments. Further, the video component 316 includes individual frames of video, such as video frame 323.

Relying upon content marker command inputs, as described herein, certain segments or components of the video content 310 may be specified for playback in a segmented resource identifier. For example, a range 320 of the video content 310 may be specified. The range 320 includes a range of the metadata 312, audio 314, and video 316 components. As other examples, any one of the metadata X, Y, or Z components, the ranges 321 or 322 of the audio component 314, the ranges 324 or 325 of the video component 316, or the video frame 323 (or image) of the video component 316 may be specified.

FIG. 3 is illustrated to provide representative examples of segments or components of the video content 310 that may be specified for playback in a segmented resource identifier. That is, when generating a segmented resource identifier that identifies (e.g., links to) the video content 310 of FIG. 3, the content reference generator 108 may generate the segmented resource identifier to include one or more playback attributes which specify one or more of the segments or components 320-325 (or the metadata) of the video content 310 of FIG. 3. It should be appreciated that the video content 310 in FIG. 3 is provided as one example of content which may be referenced according to the embodiments described herein. The embodiments may reference various types and formats of content, including video, audio, and image content, among others, without limitation.

Turning to FIG. 4, an example format of a segmented resource identifier 410 generated by the system 10 of FIG. 1 is illustrated, according to various embodiments described herein. The segmented resource identifier 410 includes a URI and at least one playback attribute, as illustrated. In the context of the system 10 of FIG. 1, the URI may specify content stored on the content repository 130, for example.

The segmented resource identifier 410 may be generated by the content reference generator 108, as described herein, with reference to or based on one or more content marker command inputs received from a user. Further, as described herein, the segmented resource identifier 410 may be shared or circulated to one or more parties via e-mail, SMS, MMS, or posting to a social networking website or distribution channel.

Once the segmented resource identifier 410 has been circulated to a party, the party, as a user of the playback device 140, may use the segmented resource identifier 410 to identify and request (e.g., from the content repository 130) content identified by the URI of the segmented resource identifier 410, for playback. In turn, upon receiving the request for content identified by the URI, the content repository 130 may serve the content for playback according to the at least one playback attribute of the segmented content reference 410.

As illustrated, the segmented resource identifier 410 includes at least one playback attribute. The playback attributes may specify playback start time, playback end time, playback range, or playback component attributes, or combinations thereof. As one example, the URI of the segmented resource identifier 410 may specify the video content 310 of FIG. 3, and the playback attributes of the segmented resource identifier 410 may specify one or more of the segments or components 320-325 (or the metadata) of the video content 310 of FIG. 3. Thus, if the content repository 130 receives the segmented resource identifier 410 as a request for playback of content, then the content repository may serve one or more of the segments or components 320-325 (or the metadata) of the video content 310 of FIG. 3, based on the playback attributes of the segmented resource identifier 410.

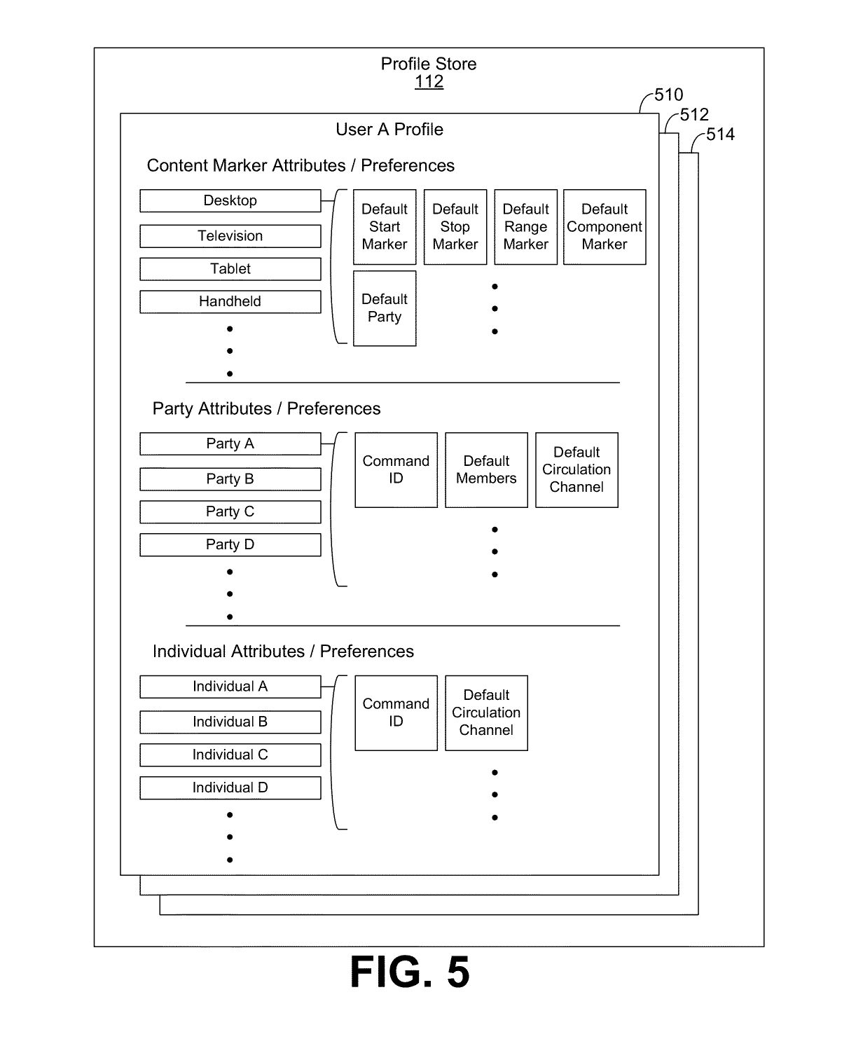

FIG. 5 illustrates an example organization of the profile store 112 relied upon by the system 10 of FIG. 1, according to various embodiments described herein. As described above, the profile store 112 may be referenced by the content marker evaluator 106, the content reference generator 108, or the content reference publisher 110 of the interface device 100 of FIG. 1, when evaluating content marker command inputs, generating segmented resource identifiers, or identifying parties or channels for circulation of segmented resource identifiers, for example.

As illustrated in FIG. 5, the profile store 112 is organized into profiles 510, 512, and 514, for respective users. Each user may specify default settings for various content marker command inputs. In one embodiment, a user may specify default settings for marker command inputs, for different devices. In other words, the default marker command input for specifying a content start time may be different depending upon whether a user provides the command via a desktop computer, a television, a tablet computing device, or a handheld computing device. The benefits of being able to specify these device-specific profile differences may be attributed, for example, to the fact that each device includes different means for providing input from a user. For example, when using a tablet device, a content start marker command input may be most readily or easily specified by the gesture 220 of FIG. 2A, whereas, when using a desktop computer, the content start marker command input may be easily specified using a keyboard or other similar input device.

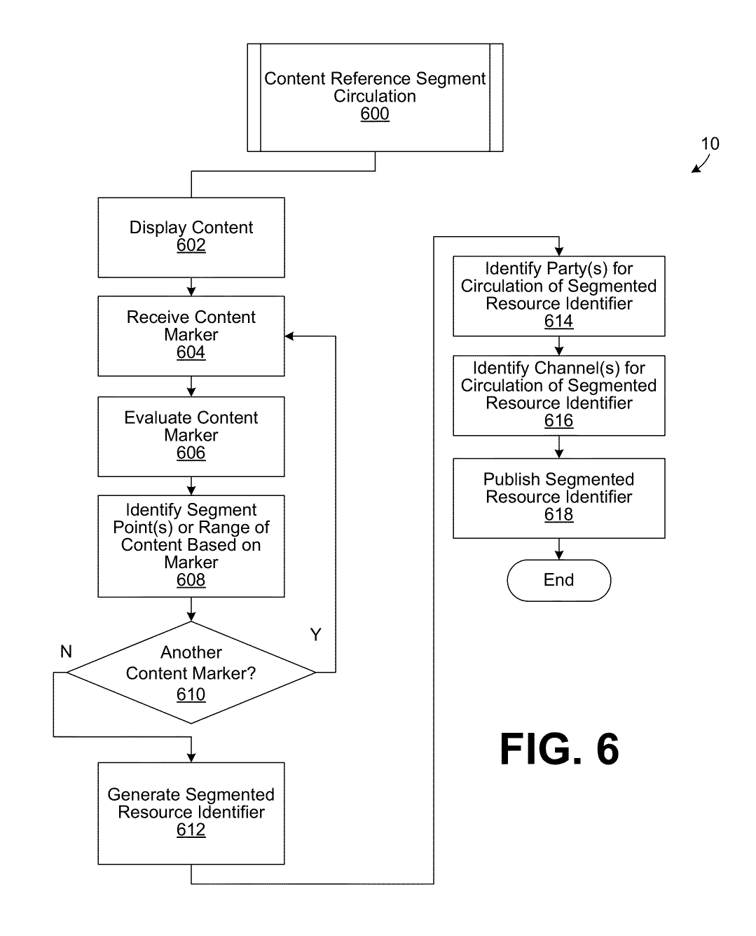

In the profile store 112, each user may specify default settings for the identification of one or more parties. As illustrated in FIG. 6, each party A, B, C, and D may be associated with a particular marker command input identifier. That is, a certain marker command input may identify that a segmented resource identifier should be circulated to a particular party. Each party may be defined by a default set of one or more members and a default channel for circulation of segmented resource identifiers. For example, for party A, the default members may include a user's family members, and the default circulation channel may define circulation via e-mail. In contrast, for party B, the default members may include a user's friends, and the default circulation channel may define circulation via a social networking website.

Each user may also specify default settings for individuals in the profile store 112. As illustrated in FIG. 6, each individual A, B, C, and D may be associated with a particular marker command input identifier. That is, a certain marker command input may identify that a segmented resource identifier should be circulated to a particular individual. Each individual may be defined by a default channel for circulation of a segmented resource identifier. For example, for individual A, the default circulation channel may define circulation via e-mail. In contrast, for individual B, the default circulation channel may define circulation via a social networking website.

It should be appreciated that the organization and content of the attributes and preferences for the content markers, the parties, and the individuals, per user, as illustrated in the profile store 112 in FIG. 5, is provided by way of example only. Other attributes and preferences, and organizations thereof, are within the scope and spirit of the embodiments described herein. Generally, the profile store 112 may be referenced by the content marker evaluator 106, the content reference generator 108, or the content reference publisher 110 of the interface device 100 of FIG. 1, when evaluating content marker command inputs, generating segmented resource identifiers, or identifying parties or channels for circulation of segmented resource identifiers.

Referring next to FIG. 6, a flowchart illustrating example operations of the interface device 100 of the system 10 of FIG. 1 are provided. In certain aspects, the flowchart of FIG. 6 may be viewed as depicting example steps of a method of segmented content reference circulation. Although the processes of FIG. 6 are described in connection with interface device 100 of FIG. 1, other devices may operate according to the processes illustrated. Further, it should be understood that the flowcharts of FIG. 6 provide only one example of different functional or process arrangements that may be employed according to the embodiments described herein.

FIG. 6 illustrates an example process flow of a segmented content reference circulation process 600 performed by the interface device 100 of the system 10 of FIG. 1, according to various embodiments described herein. At reference numeral 602, the process 600 includes displaying content on a display. According to the examples described herein, media content stored on the content repository 130 may be displayed on the local display 120 or the interface display 102 of the interface device 100 (FIG. 1) at reference numeral 602.

At reference numeral 604, the process 600 includes receiving a marker associated with the content under display at reference numeral 602. For example, while content is being displayed on the interface display 102 at reference numeral 604, a user of the interface device 100 may input one of the content marker command input gestures 220, 222, and 224 illustrated in FIGS. 2A-2C, to mark a start time, end time, or playback range associated with the content under display. Particularly, according to the embodiments described herein, upon viewing the content under display at reference numeral 602, a user may desire to share a reference or link to the content to a friend or family member. Further, the user may wish to identify one or more particular segments of the content for sharing. Thus, the user may input one of the content marker command input gestures 220, 222, and 224 illustrated in FIGS. 2A-2C, for example, to mark one or more start times, end times, or playback ranges associated with the content under display.

Continuing to reference numeral 606, the process 600 includes evaluating a type and attribute of the marker received at reference numeral 602. As noted above, the evaluation of the type and attribute of the marker may be performed by the content marker evaluator 106 of the interface device 100 (FIG. 1). In various embodiments, the evaluated type of the marker may include at least one of a start, stop, range, media component, forward range, reverse range, or publish type marker, among others. In various embodiments, the evaluated attribute may include at least one of a start time, end time, or time range, for example, determined with reference to the content under display at reference numeral 602. Further, as described above with reference to FIGS. 1 and 5, the evaluation of the type and attribute of a marker at reference numeral 602 may be based, at least in part, on information stored in the profile store 112.

Referring to the type and attribute of the marker, at reference numeral 608, the process 600 includes identifying a segment point of the content under display with reference to the type and attribute of the marker. Here, the segment point may be a start or stop point. Particularly, a user may desire to generate a segmented resource identifier that references the content under display, along with a reference start time for starting playback of the content. Alternatively, a user may desire to generate a segmented resource identifier that references the content under display, along with a reference end time for ending playback of the content. In other variations, as described herein, a user may desire to generate a segmented resource identifier that references the content under display, along with one or more ranges of the content for playback, one or more components of content for playback, etc. In this context, at reference numeral 608, the process 600 includes identifying one or more segment points of the content under display with reference to the type and attribute of the marker received at reference 604.

The segment points identified at reference numeral 608 may be start and end times, or time ranges, for example. In other words, for a start-type marker, a start segment point may be identified at reference numeral 608 with reference to the attribute of the marker. Similarly, for an end-type marker, an end segment point may be identified at reference numeral 608 with reference to the attribute of the marker. Examples of these start and end segment points are provided in FIGS. 2A and 2B, at timings of 1:06 and 3:48 minutes.

Because various types of markers, such as start, stop, range, media component, forward range, reverse range, or publish type markers, for example, are within the scope and spirit of the embodiments described herein, various types and timings of segment points may be identified at reference numeral 608. As another example, a segment “range” may be identified at reference numeral 608. In other words, if a type of a marker received at reference numeral 604 is evaluated at reference numeral 606 to be a forward or reverse range marker type, a time range for the marker may be identified at reference numeral 608, based on an attribute of the marker.

An example of a segment range is provided in FIG. 2C, at a timing of 1:20-4:45 minutes. Here, it is noted that both forward and reverse range markers are within the scope of the embodiments described herein. That is, a reverse range marker may be input by a user at the time “B” in FIG. 2C, and reference a certain backward-looking time range in content under display. In other words, by input of a reverse range marker, a user may identify that he wishes to reference the previous 25 seconds, for example, of content. Similarly, a forward range marker may be input by a user at the time “A” in FIG. 2C, and reference a certain forward-looking time range in content under display. In other words, by input of a forward range marker, a user may identify that he wishes to reference the next 25 seconds, for example, of content. Further, as described above with reference to FIGS. 1 and 5, the identification of segment points at reference numeral 608 may be based, at least in part, on information stored in the profile store 112. For example, a default time range for forward and backward range markers may be stored in the profile store 112, per user, and per device, etc.

Further, with reference to media component-type markers, identifying a segment point of content at reference numeral 608 may include identifying a media component of the content. That is, an image, audio, video, or metadata component of the content may be identified. In certain cases, after a component is identified, a range of that component may be identified at reference numeral 608. For example, one or more of the components 320-325 (or the metadata) of the video content 310 of FIG. 3 may be identified. It should be appreciated that, because a single component of media content may be identified, a segmented resource identifier may be generated, as described below, that refers to only that component for playback.

At reference numeral 610, the process 600 includes determining whether another content marker has been input. If another marker has been input by a user, the process 600 proceeds back to reference numeral 604 to receive the input. Otherwise, the process proceeds to reference numeral 612 to generate a segmented resource identifier. Generally, any number of markers may be received and evaluated before a segmented resource identifier is generated. Thus, second, third, fourth, etc., markers may be received at reference numeral 602.

In certain embodiments, the determination at reference 610 may be based on whether a publish-type marker has been received. In other words, a user may rely upon a publish-type marker to identify that he wishes to generate and circulate a segmented resource identifier, after providing one or more start, stop, or range-type markers which define segments or components of content to share. Upon receipt of the publish-type marker, the process may proceed directly to reference numeral 612, for generating a segmented resource identifier.

At reference numeral 612, the process 600 includes generating a segmented resource identifier. In exemplary embodiments, the segmented resource identifier identifies the content under display at reference numeral 602 and includes, based on one or more segment points identified at reference numeral 608, a least one playback attribute for rendering playback of the content. Examples of segmented resource identifiers are provided above with reference to FIG. 4.

It is noted that aspects of the embodiments described herein may be relied upon to generate segmented resource identifiers for stored content, without the concurrent display of that content. That is, the embodiments described herein may be relied upon to generate a segmented resource identifier for content that is not under display, for example, by a user that provides type (i.e., start, stop, range) and attribute (i.e., timing) inputs for the generation of the resource identifier. Thus, so long as a user identifies a uniform resource locator for content, for example, along with the parameters for the segments or components of that content which are specified playback, a segmented resource identifier may be generated at reference numeral 612.

At reference numerals 614 and 616, the process 600 includes identifying a party and a channel for circulation of the segmented resource identifier generated at reference numeral 612. The party and channel may be identified in response to receipt of a certain party-type marker. The party and channel may be further identified based on information stored in the profile store 112 (FIGS. 1 and 5). The profile store 112 may include a circulation profile that defines a plurality of parties for circulation, each party for circulation including a default set of members for the party, a default circulation channel preference for the party, and a default media component preference for the party, as described above with reference to FIG. 5.

According to the examples provided herein, the party may include a friend, group of friends, family member, or group of family member, or any individual or group of individuals. Further, the channel for circulation may include one or more e-mail, SMS, or MMS addresses, for example. The channel for circulation may alternatively or additionally include one or more social networking websites.

At reference numeral 618, the process 600 includes publishing the segmented resource identifier generated at reference numeral 612 to the party identified at reference numeral 614 via the channel for circulation identified at reference numeral 618. After the segmented resource identifier is received, a user of a playback device may rely upon the segmented resource identifier to request a certain portion or segment of content for playback. As for a user of a playback device that receives a segmented resource identifier, rather than referring to content in its entirety, the user is able to reference a certain portion or segment of the content for playback.

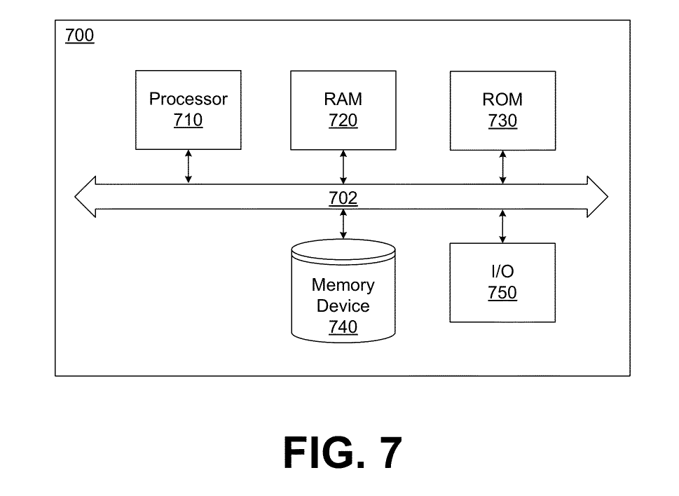

FIG. 7 illustrates an example schematic block diagram of a computing architecture 700 that may be employed by one or more elements of the system 10 of FIG. 1, according to various embodiments described herein. The computing architecture 700 may be embodied, in part, using one or more elements of a mixed general and/or special purpose computer. The computing device 700 includes a processor 710, a Random Access Memory (RAM) 720, a Read Only Memory (ROM) 730, a memory device 740, and an Input Output (I/O) interface 750. The elements of computing architecture 700 are communicatively coupled via a bus 702. The elements of the computing architecture 700 are not intended to be limiting in nature, as the architecture may further additional or alternative elements.

In various embodiments, the processor 710 may include any general purpose arithmetic processor, state machine, or Application Specific Integrated Circuit (ASIC), for example. In various embodiments, the interface device 100 of FIG. 1 may be implemented, at least in part, by the processor 710. The processor 710 may include one or more circuits, one or more microprocessors, ASICs, dedicated hardware, or any combination thereof. In certain aspects and embodiments, the processor 710 is configured to execute one or more software modules. The processor 710 may further include memory configured to store instructions and/or code to perform various functions, as further described herein. In certain embodiments, the process 600 described in connection with FIG. 6 may be implemented or executed by the processor 710.

The RAM and ROM 720 and 730 include any random access and read only memory devices that store computer-readable instructions to be executed by the processor 710. The memory device 740 stores computer-readable instructions thereon that, when executed by the processor 710, direct the processor 710 to execute various aspects of the embodiments described herein.

As a non-limiting example group, the memory device 740 includes one or more of an optical disc, a magnetic disc, a semiconductor memory (i.e., a semiconductor, floating gate, or similar flash based memory), a magnetic tape memory, a removable memory, combinations thereof, or any other known non-transitory memory means for storing computer-readable instructions. The I/O interface 750 includes device input and output interfaces, such as keyboard, pointing device, display, communication, and/or other interfaces. The bus 702 electrically and communicatively couples the processor 710, the RAM 720, the ROM 730, the memory device 740, and the I/O interface 750, so that data and instructions may be communicated among them.

In certain aspects, the processor 710 is configured to retrieve computer-readable instructions and data stored on the memory device 740, the RAM 720, the ROM 730, and/or other storage means, and copy the computer-readable instructions to the RAM 720 or the ROM 730 for execution, for example. The processor 710 is further configured to execute the computer-readable instructions to implement various aspects and features of the embodiments described herein. For example, the processor 710 may be adapted or configured to execute the process 600 described above in connection with FIG. 6. In embodiments where the processor 710 includes a state machine or ASIC, the processor 710 may include internal memory and registers for maintenance of data being processed.

The flowchart or process diagram of FIG. 6 is representative of certain processes, functionality, and operations of embodiments described herein. Each block may represent one or a combination of steps or executions in a process. Alternatively or additionally, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as the processor 710. The machine code may be converted from the source code, etc. Further, each block may represent, or be connected with, a circuit or a number of interconnected circuits to implement a certain logical function or process step.

Although the flowchart or process diagram of FIG. 6 illustrates an order, it is understood that the order may differ from that which is depicted. For example, an order of execution of two or more blocks may be scrambled relative to the order shown. Also, two or more blocks shown in succession in FIG. 6 may be executed concurrently or with partial concurrence. Further, in some embodiments, one or more of the blocks shown in FIG. 6 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present invention defined in the following claims, the scope of which are to be accorded the broadest interpretation so as to encompass modifications and equivalent structures.

At least the following is claimed:

1. A method, comprising:
receiving a marker associated with content displayed on a display;
evaluating a type and an attribute of the marker;
identifying, by a processor, a segment point of the content with reference to the type and attribute of the marker; and
generating a segmented resource identifier that identifies at least a portion of the content based on the segment point.

2. The method of claim 1, wherein the segmented resource identifier comprises a playback attribute including at least one of a playback start time, a playback end time, or a playback time range for the content.

3. The method of claim 1, further comprising identifying a party and a channel for circulation of the segmented resource identifier based on a content circulation profile.

4. The method of claim 3, further comprising publishing the segmented resource identifier to the party via the channel for circulation.

5. The method of claim 3, wherein the content circulation profile includes a circulation address for each individual in the party for circulation, at least one circulation channel preference for the party for circulation, and a media component preference for the party for circulation.

6. The method of claim 3, wherein the content circulation profile defines a plurality of parties for circulation, each party for circulation comprising a default set of members for the party, a default circulation channel preference for the party, and a default media component preference for the party.

7. The method of claim 1, wherein the type of the marker comprises at least one of start, stop, range, media component, forward range, reverse range, or publish type marker.

8. The method of claim 1, further comprising:
receiving a second marker associated with the content;
evaluating a type and attribute of the second marker; and
identifying a second segment point of the content with reference to the type and attribute of the second marker, wherein
generating a segmented resource identifier comprises generating a playback attribute range of the segmented resource identifier, the playback attribute range defining a playback range of the content based on the segment point and the second segment point.

9. The method of claim 1, wherein identifying a segment point of the content comprises identifying a forward or reverse segment range of the content based on the type and attribute of the marker.

10. The method of claim 1, wherein:
identifying a segment point of the content comprises identifying a segment range of a media component of the content based on the type and attribute of the marker; and
the media component comprises at least one of an image, audio, video, or metadata component of the content.

11. A system, comprising:
an interface sensor that captures user input;
a content marker evaluator configured to:
receive a marker associated with content based on user input captured by the interface sensor; and
evaluate a type of the marker and identify a segment point of the content with reference to the type of the marker; and
a content reference generator configured to generate a segmented resource identifier that identifies at least a portion of the content based on the segment point.

12. The system of claim 11, wherein the segmented resource identifier comprises a playback attribute including at least one of a playback start time, a playback end time, or a playback time range for the content.

13. The system of claim 11, further comprising a content reference publisher configured to:
identify a party and a channel for circulation of the segmented resource identifier based on a content circulation profile; and
publish the segmented resource identifier to the party via the channel for circulation.

14. The system of claim 11, wherein the type of the marker comprises at least one of start, stop, range, media component, forward range, reverse range, or publish type marker.

15. The system of claim 11, wherein the content marker evaluator is further configured to:
receive a second marker associated with the content;
evaluate a type of the second marker; and
identify a second segment point of the content with reference to the type of the second marker.

16. A computer readable medium storing computer-readable instructions thereon that, when executed by processing circuitry, directs the processing circuitry to:
evaluate a marker associated with content;
identify a segment point of the content with reference to the marker;
generate a segmented resource identifier that identifies at least a portion of the content based on the segment point; and
publishes the segmented resource identifier.

17. The computer readable medium of claim 16, wherein the segmented resource identifier comprises a playback attribute including at least one of a playback start time, a playback end time, or a playback time range for the content.

18. The computer readable medium of claim 16, wherein the processing circuitry is further directed to identify a party and a channel for circulation of the segmented resource identifier based on a content circulation profile.

19. The computer readable medium of claim 18, wherein the processing circuitry is further directed to publish the segmented resource identifier to the party via the channel for circulation.

20. The computer readable medium of claim 16, wherein the processing circuitry is further directed to:
evaluate a second marker associated with the content;
identify a second segment point of the content with reference to a type and attribute of the second marker; and
generate a playback attribute range of the segmented resource identifier, the playback attribute range defining a playback range of the content based on the segment point and the second segment point.
